(19) United States
(12) Patent Application Publication
(10) Pub. No.: US 2008/0289454 A1
(43) Pub. Date: Nov. 27, 2008

(54) Wrench

(76) Inventor: Tony Petkovic, Vancouver (CA)

Correspondence Address: Orum & Roth LLC;Ste. 1616, 53 W. Jackson Blvd., Chicago, IL, 60604, US

(21) Appl. No.: 11/450,882

(22) Filed: Jun. 9, 2006

Related U.S. Application Data
(63) Continuation-in-part of application No. 10/906,924, filed on Mar. 12, 2005, now abandoned.

(51) Int. Cl. B25B 13/28

(52) U.S. Cl. 81/99; 81/111

(57) ABSTRACT

A wrench capable of engaging a workpiece from the side or top. When the workpiece is engaged on the side, a movable jaw opens when a slight pressure is applied against a flat or a point of the nut or bolt. After the jaws of the wrench have pushed past the workpiece, a pin and spring mechanically return the moveable jaw to its closed position. In its closed position, the workpiece is retained by the jaws in the proper seat position. When tightening or loosening the workpiece, the direction of the pull is towards the fixed jaw. Disengagement between pulls is accomplished by turning in the opposite direction of pull. The wrench rides over the points of the workpiece and automatically reseats itself.

### BACKGROUND OF THE INVENTION

1. Field of the Invention

The present invention related to a wrench. More particularly, the present invention relates to a fixed ratchet wrench that can engage the workpiece by being placed over the top of the bolt head or by slipping the side of bolt head through an expandable jaw opening. The inventive wrench is also able to ratchet from the side.

2. Description of Related Art

Prior art wrenches are of several basic types. Wrenches have fixed or adjustable jaws or sockets either at the end or between the ends of a lever. Wrenches are used for holding or turning a workpiece. There are two general types of wrenches, pipe wrenches used in plumbing and general use wrenches used to hold or turn nuts and bolts that have flat parallel surfaces.

There are several general types of general-use wrenches. General use wrenches may be adjustable or fixed-sized. Adjustable wrenches can be adjusted to be used with more than one size nut or bolt. Fixed-size wrenches fit a single specific sized nut or bolt. Fixed-size wrenches can be box wrenches, open-ended wrenches, or socket wrenches. Some fixed-sized wrenches are ratchet wrenches. Ratchet wrenches are designed so that torque is applied only in a single direction.

Box wrenches and socket wrenches can only engage with the workpiece by being slipped over the head of the nut or bolt. Thus, they can only be used in positions where the nut or bolt is accessible from the top. Open ended wrenches can be used to hold or tighten workpieces that can be only engage a portion of the nut or bolt. Thus, torque is not applied to all the flats. Prior art wrenches require that the wrench be placed on the nut in the correct seat position.

There is a need for a wrench that can engage nuts or bolts from the side or the top and that engages the majority of the nut head.

There is a need for a wrench that can engage nuts from the side whether the jaw opening engages a flat or a point and that will automatically seat the nut in the proper position.

There is a need for a wrench with no levers to set. There is a need for a rebuildable with limited components and few moving parts.

### SUMMARY OF THE INVENTION

A wrench that is capable of engaging a workpiece, such as a bolt or nut from the side as well as from the top. The wrench is a ratchet wrench. Thus, torque is only applied in one direction, the pull direction. The wrench can be rotated in the opposite direction from the pull direction. When rotated in the opposite direction from the pull direction, a moveable jaw opens and the wrench slides over a point of the workpiece into the successive seat position. The opening rate of the moveable jaw during the ratcheting is controlled by an internal spring. The capability to ratchet the wrench facilitates working in very tight spaces. Unlike traditional open-end wrenches, it is not necessary to remove and reposition the wrench after each pull.

The jaws of the wrench substantially encircle the bearing surface of the workpiece. Preferably, at least about 75% of bearing surface of the workpiece is encircled by the jaws of the wrench. More preferably the jaws of the wrench encircle about 85% of the circumference of the workpiece.

Workpiece can be engaged from the top of the side. When the workpiece is engaged from the top, the jaws of the wrench are slipped over the top of the nut or the bolt. When the workpiece is engaged on the side, the movable jaw opens when a slight pressure is applied by the operator against the side of the nut. The jaws are angled to open and accept the workpiece, whether a flat or a point of the workpiece is encountered by the jaw opening. The opening rate of the moveable jaw is controlled by an internal spring. After the jaws of the wrench have pushed past the workpiece, a pin and spring mechanically return the moveable jaw to its closed position. In its closed position, the workpiece is retained by the jaws in the proper seat position. The ability to apply the wrench to the workpiece at either a point or a flat, facilitates working in very tight spaces. Further, there is no need to align the wrench before it is applied to the workpiece.

The direction of force for either tightening or loosening is determined by the side of the hinge relative to the work. In the case of a right hand screw, tightening requires the moveable jaw to be on the right and loosening requires the moveable jaw on the left. For a left hand screw, the moveable jaw is on the left for tightening and on the right for loosening. When turning the workpiece, the direction of the pull is towards the fixed jaw. Disengagement between pulls is accomplished by turning in the opposite direction of pull. The wrench rides over the points of the workpiece and automatically reseats itself.

### BRIEF DESCRIPTION OF THE FIGURES

FIG. 1 is a perspective view of the wrench with a six-point mouth.

FIG. 2a is a side view of the wrench with a six-point mouth.

FIG. 2b is a side view of the wrench with a six-point mouth and shields.

FIG. 2c is a side view of the wrench with a twelve-point mouth.

FIG. 2d is a side view of the wrench with a twelve-point mouth and shields.

FIG. 3a is a top view of the wrench with a six-point mouth.

FIG. 3b is a top view of the wrench with a six-point mouth and shields.

FIG. 3c is a top view of the wrench with a twelve-point mouth.

FIG. 3d is a top view of the wrench with a twelve-point mouth and shields.

FIG. 4a is a cross sectional view of the wrench with a six-point mouth.

FIG. 4b is a cross sectional view of the wrench with a twelve-point mouth.

FIG. 4c is a cross sectional view of the wrench with a six-point mouth with shields.

FIG. 4d is a cross sectional view of the wrench with a twelve-point mouth with shields.

FIG. 4e is a cross sectional view of an alternative wrench with a six-point mouth.

FIG. 4f is a cross sectional view of an alternative wrench with a twelve-point mouth.

FIG. 4g is a cross sectional view of an alternative wrench with a six-point mouth with shields.

FIG. 4h is a cross sectional view of an alternative wrench with a twelve-point mouth with shields.

FIG. 5a is a side view of the fixed jaw portion with for a six-point mouth.

FIG. 5b is a side view of the fixed jaw portion for a six-point mouth with shields.

FIG. 6a is a top view of the fixed jaw portion for a six-point mouth.

FIG. 6b is a top view of the fixed jaw portion for a six-point mouth with shields.

FIG. 7a is a side view of the moveable jaw portion for a six-point mouth.

FIG. 7b is a side view of the moveable movable portion for a twelve-point mouth.

FIG. 8 is a top view of the moveable jaw portion for a six-point mouth.

FIG. 9 is a perspective view of the moveable jaw portion for a six-point mouth.

FIG. 10 is a bottom view of the moveable jaw portion.

FIG. 11 is a shield.

FIG. 12 is the spring.

FIG. 13 is the connector pin.

FIG. 14 is the internal stop.

FIG. 15a is a close up of wrench head with a six-point mouth.

FIG. 15b is a close up of a wrench head with a twelve-point mouth.

FIG. 15c is a close-up cross section of a wrench head with a six-point mouth.

FIG. 15d is a close-up of a cross section of a wrench head with a twelve-point mouth.

FIG. 16a is a close up of the wrench mouth with a workpiece seated therein.

FIG. 16b is a close-up of the wrench mouth sliding over a workpiece to a successive seat position.

FIG. 17a is a close-up of the wrench mouth pressing on a workpiece point.

FIG. 17b is a close-up of the wrench mouth pressing on a workpiece flat.

FIG. 18a is a cross sectional view of the wrench with a six-point mouth.

FIG. 18b is a cross sectional view of the wrench with a twelve-point mouth.

FIG. 19a is a side view of the wrench with a six-point mouth.

FIG. 19b is a side view of the wrench with a twelve-point mouth.

FIG. 19c is a side view of the wrench with a six-point mouth.

FIG. 19d is a side view of the wrench with a twelve-point mouth.

FIG. 20a is a side view of an alternative twelve-point wrench.

FIG. 20b is a first perspective view of the alternative twelve-point wrench.

FIG. 20c is a second perspective view of the alternative twelve-point wrench.

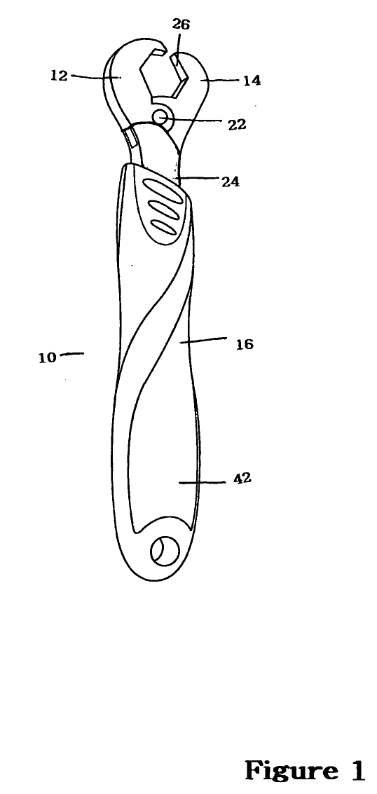

### DETAILED DESCRIPTION OF THE INVENTION

Wrench 10 is capable of engaging workpiece 50, such as a bolt or nut from the side 52 or from the top 54. Wrench 10 has moveable jaw 12 and fixed jaw 14. Workpiece 50 is seated between jaws 12, 14. When wrench 10 rotated in the opposite direction from the pull direction, moveable jaw 12 opens and the wrench 10 head slides over one point 52b of workpiece 50 into a successive seated position in wrench 10 head. The opening rate of moveable jaw 12 during the ratcheting is controlled by the tension of internal spring 20.

Wrench 10 comprises a lever 16 with fixed jaw 14 on at least a first end of lever 16 and moveable jaw 12 pivotally connected to lever 16. Jaws 12, 14 form wrench 10 head. Wrench mouth is sized to closely seat workpiece 50. More preferably, wrench mouth substantially exactly seats workpiece. It is most preferably the wrench mouth exactly seat workpiece 50, however due to machining tolerances even identically sized workpieces, such as bolts may vary in size.

Lever 16 has a bore 36 for housing a first end of compression spring 20. Axis B of bore is preferably angled β between 30° and 45° from axis A of wrench 10. More preferably, axis B is angled β is 38° from axis A of wrench 10. The bore is cylindrical in shape. Lever 16 has an aperture 36 for receiving connecting pin 22. Moveable jaw has a bore 38. Axis B1 of bore 38 is preferably aligned with axis B2 of bore 28. Bore 38 houses a second end of compression spring 20 and optional stop 18. Aperture 36 is aligned with apertures 34 in moveable jaw. Connecting pin 22 is threaded through apertures 36, 34 for rotably connecting moveable jaw 12 with lever 16.

Lever 16 preferably has a notch on each side for receiving a leg 40 of moveable jaw. Apertures 34 is located on legs 40. Aperture 32 is located on notches. Alternatively, lever 16 could have legs that mate with notches on moveable jaw 12.

Optionally, lever 16 has a pair of shields 24 to protect compression spring 20. Shields 24 can be attached to lever 16. Preferably, shields 24 and lever 16 are a single unitary piece.

Workpiece 50 can be engaged from the top 54 or side 52. When workpiece 50 is engaged from top 54, mouth of wrench 10 is slipped over top 54 of the nut or the bolt. When workpiece 50 is engaged from side 52, movable jaw 12 opens to admit workpiece 50 into wrench 50 mouth. The opening rate of moveable jaw 12 is controlled by an internal compression spring 20. As moveable jaw 12 opens, spring 20 is compressed. After workpiece 50 passes inclined shoulders 28, 30, spring 20 expands, mechanically returning moveable jaw 12 back to its closed position.

When workpiece 50 passes inclined shoulders 28, 30, wrench 10 automatically seats its self on workpiece 50 as moveable jaw 12 is closed by compression spring 20. There is no need to align the mouth of wrench 10 with workpiece 50 before engaging the workpiece.

Fixed jaw 14 has an inclined shoulder 28 and moveable jaw 12 has an inclined shoulder 30. Inclined shoulders 28, 30 are able to engage the side of workpiece 50 when pressure is applied to wrench 10 to initially seat workpiece 50 in wrench mouth. Engagement from the side occurs with slight pressure from operator (not shown) applied against the side of nut 50 against inclined shoulders 28, 30 of wrench 10. Moveable jaw 12 rotates relative to fixed jaw 14, opening mouth of wrench 10 to admit workpiece 50. Inclined shoulders 28, 30 are angled and permit rotation of moveable jaw 12 whether each shoulder 28, 30 engages a single bearing surface 52a of workpiece 50 or whether inclined shoulder 28 engages bearing surface 52a and inclined shoulder 30 engages an adjacent bearing surface 52a′.

Inclined shoulder 30 on movable jaw 12 of wrench 10 is angled ∂1 about 35°-45° from axis A of wrench 10. Preferably, inclined shoulder 30 is angled ∂1 between about 39° and 42°. Even more preferably, inclined shoulder 30 is angled ∂1 about 40°-41° from axis A of wrench.

Inclined shoulder 28 on the fixed jaw 14 of wrench 10 is angled ∂2 about 8°-20° from axis A of wrench 10. Preferably, inclined shoulder 28 is angled ∂2 about 10°-15° from axis A of wrench 10. More preferably, inclined shoulder 28 is angled ∂2 about 13°-14° from axis A of wrench 10.

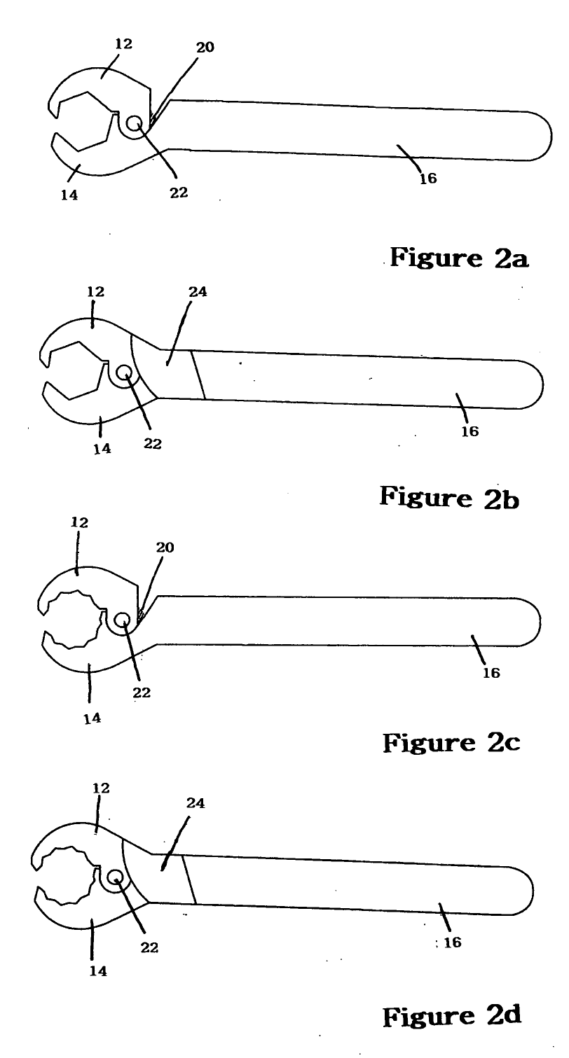

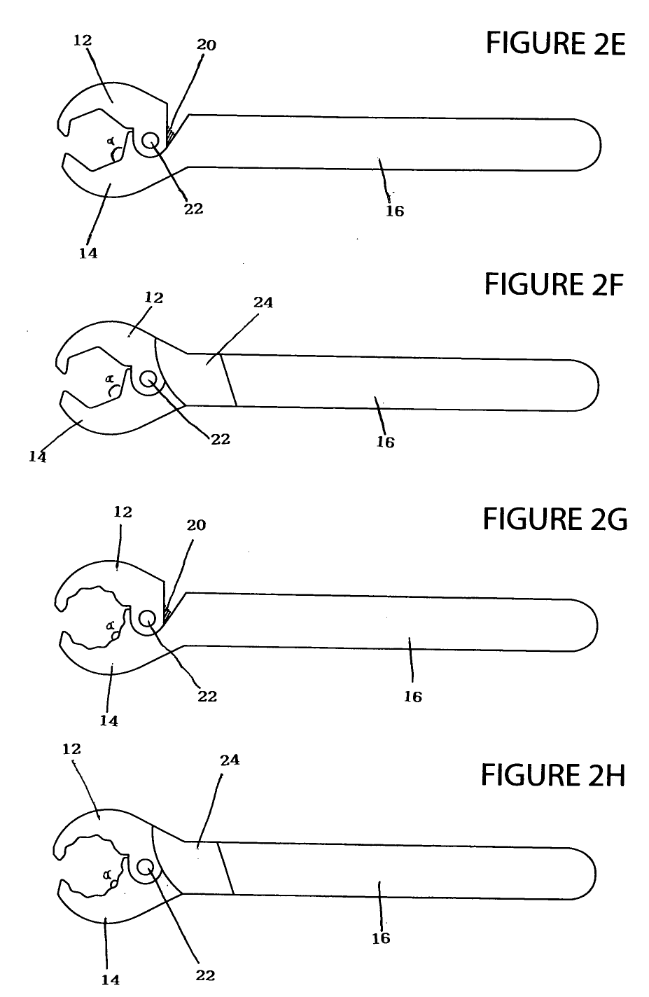

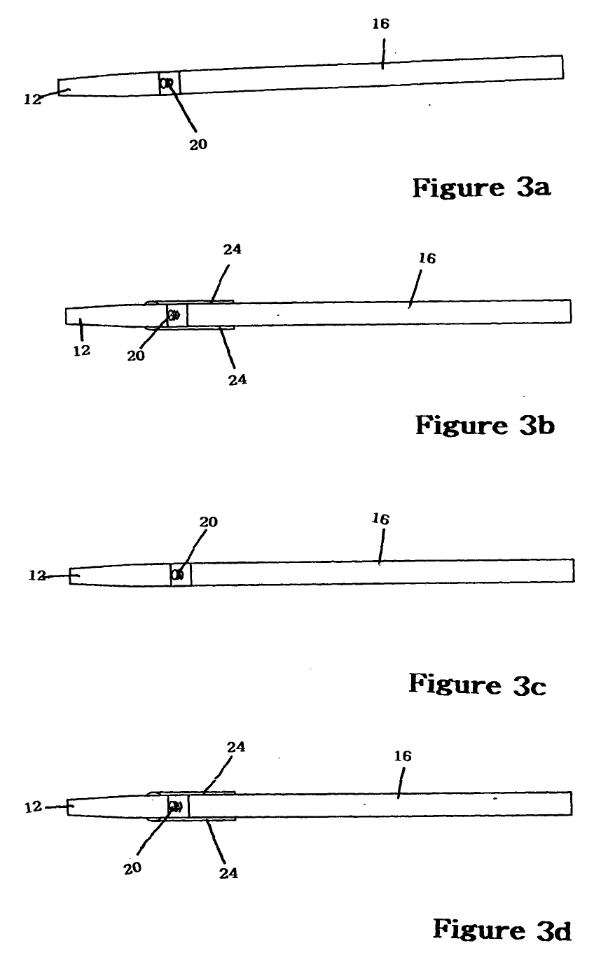

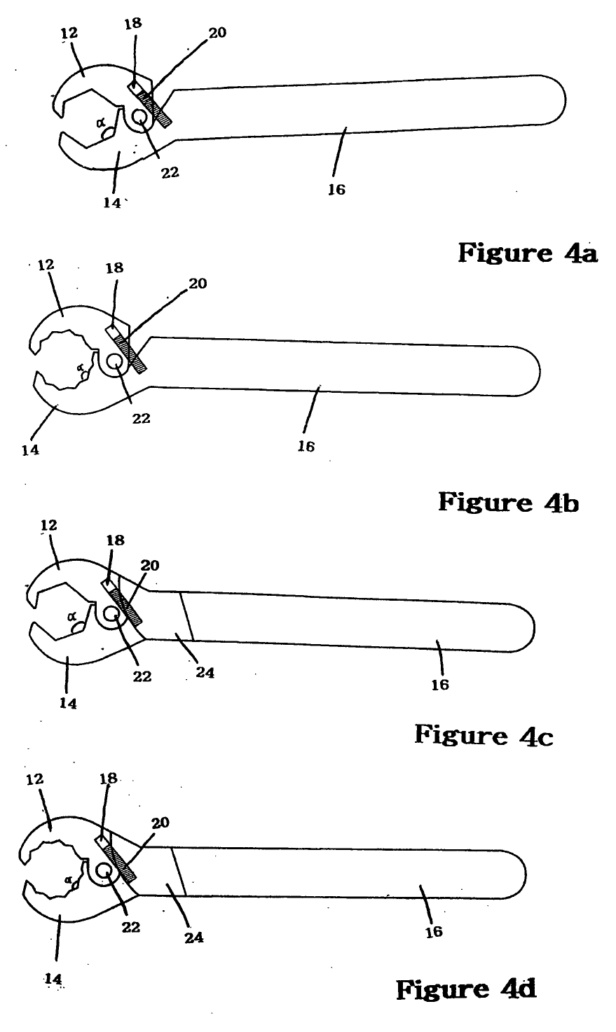

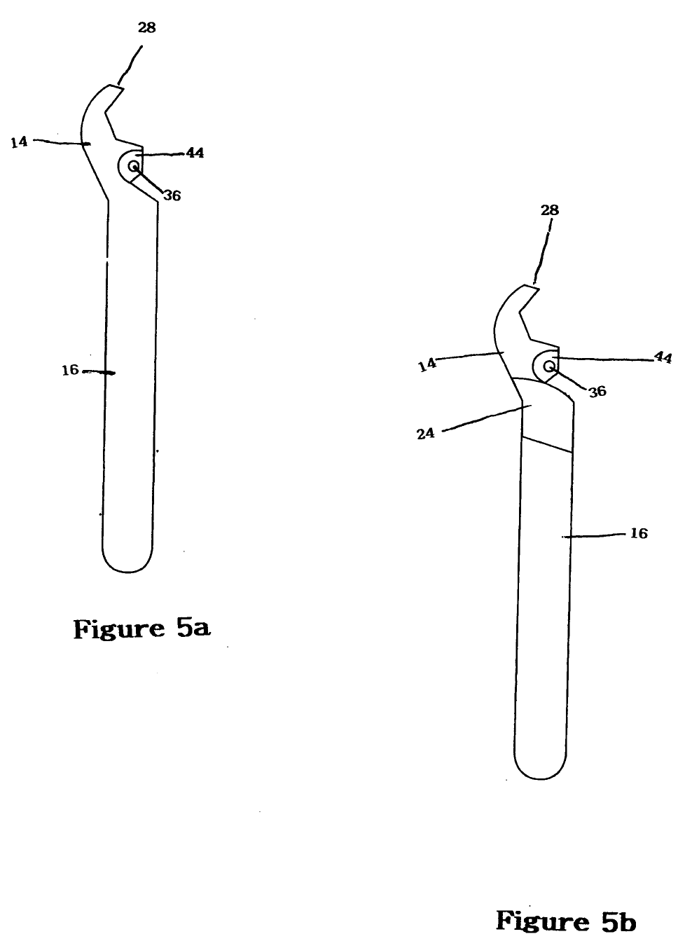

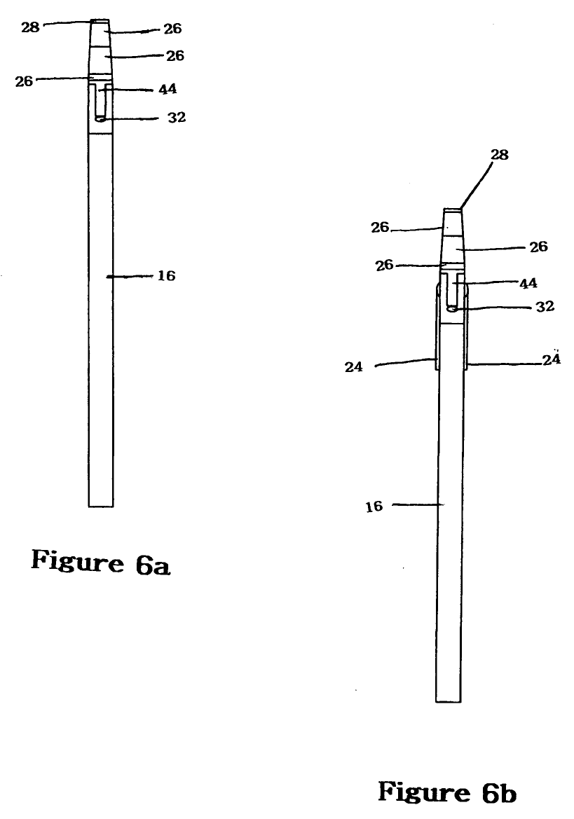

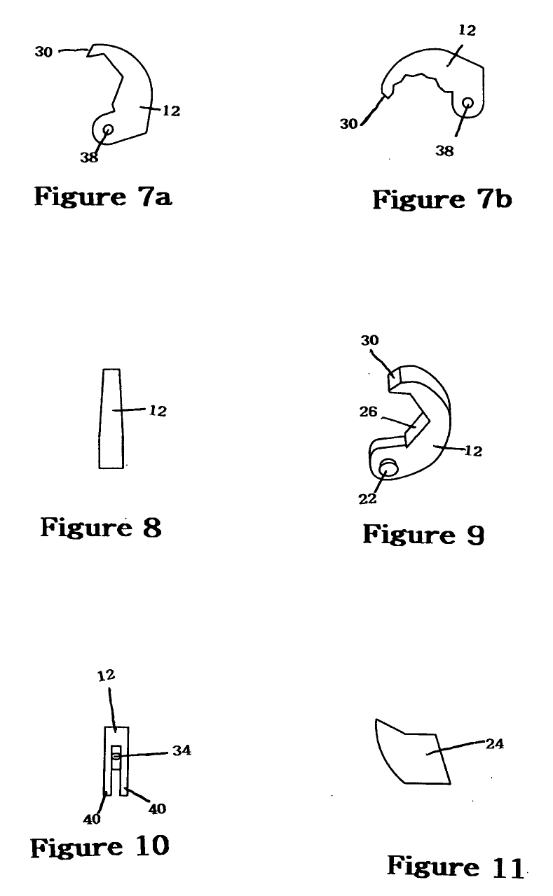

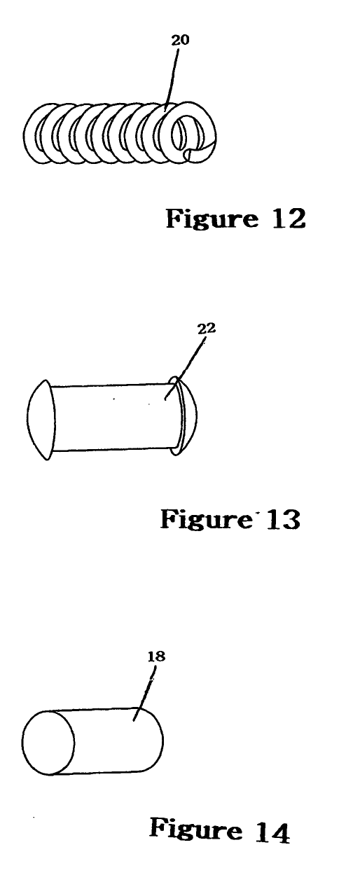

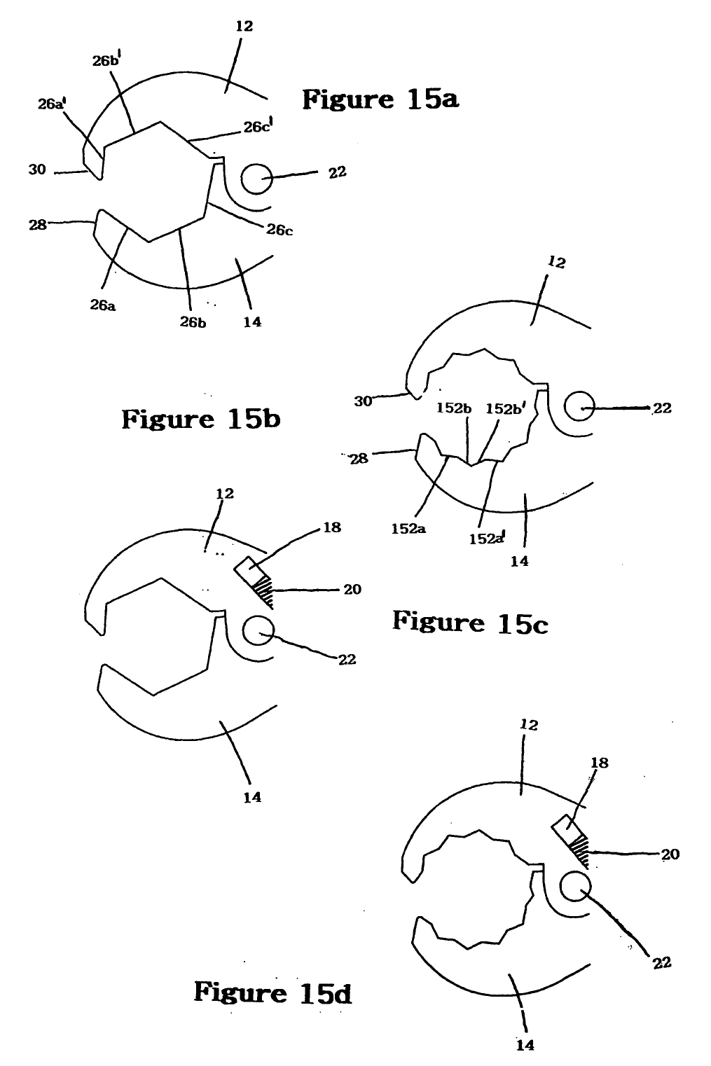

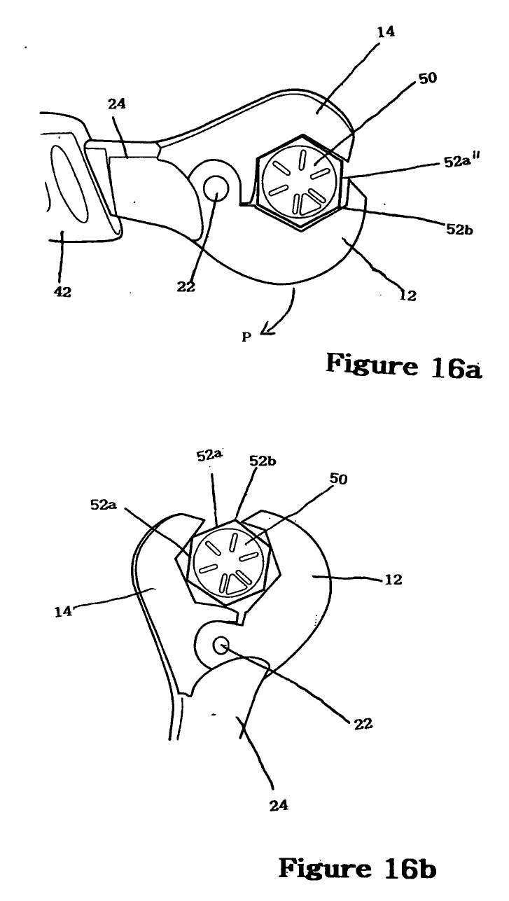

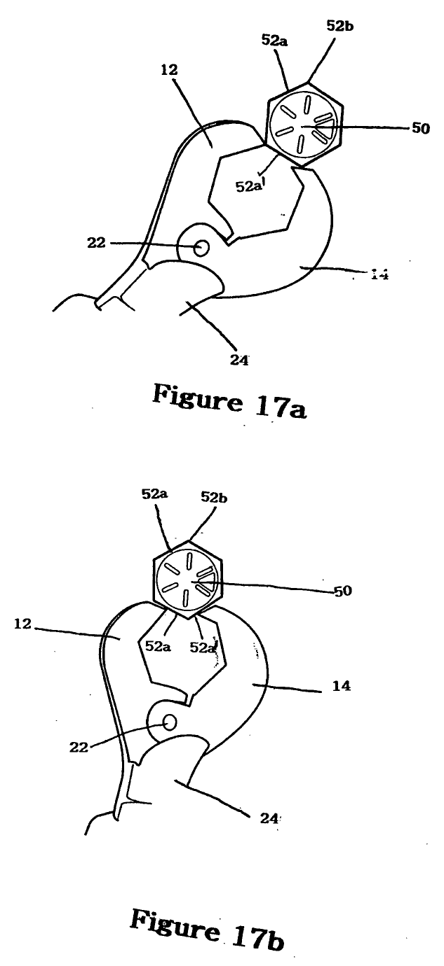

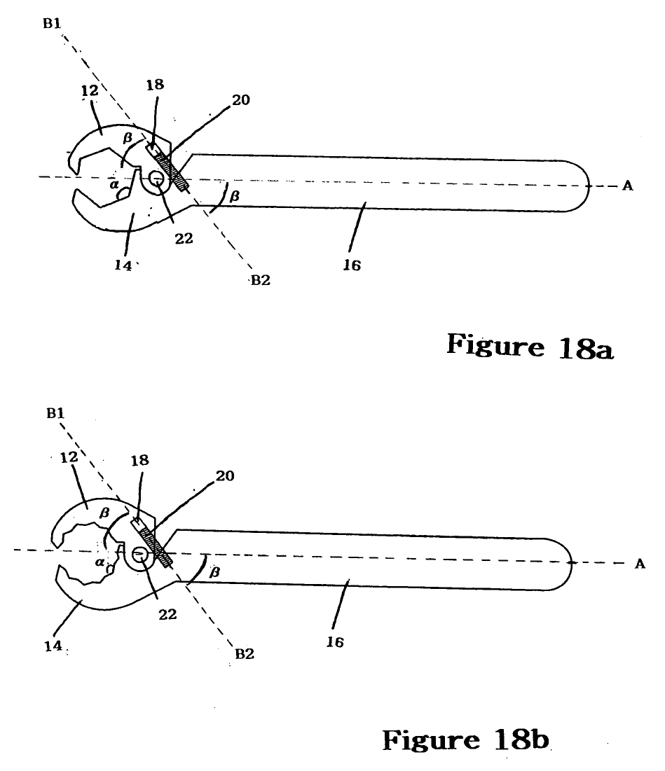

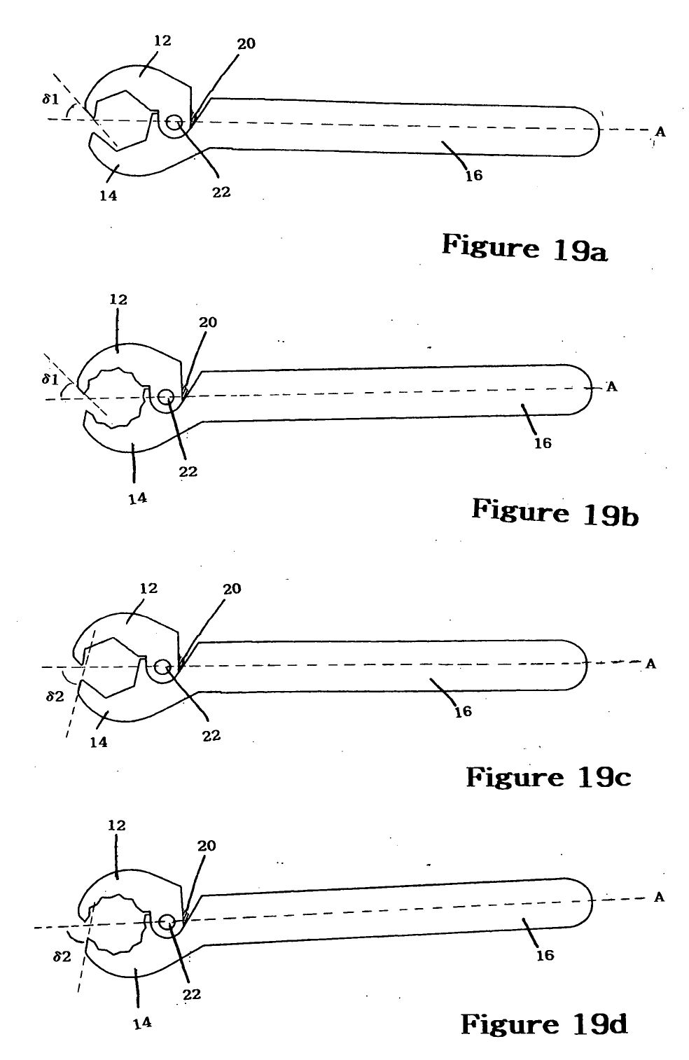

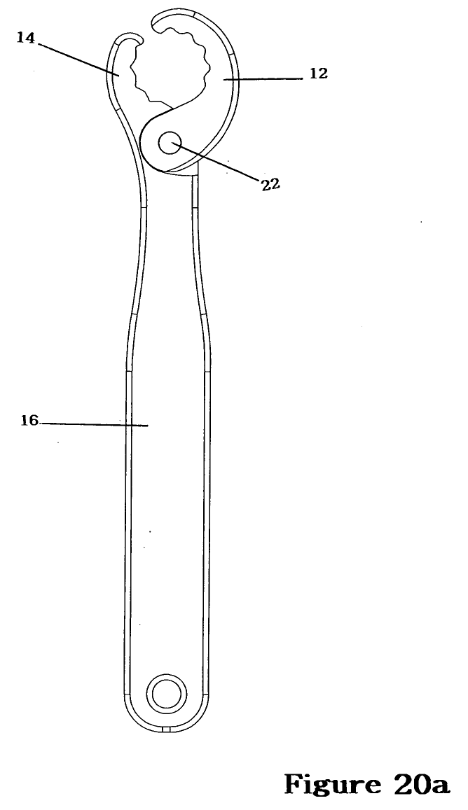

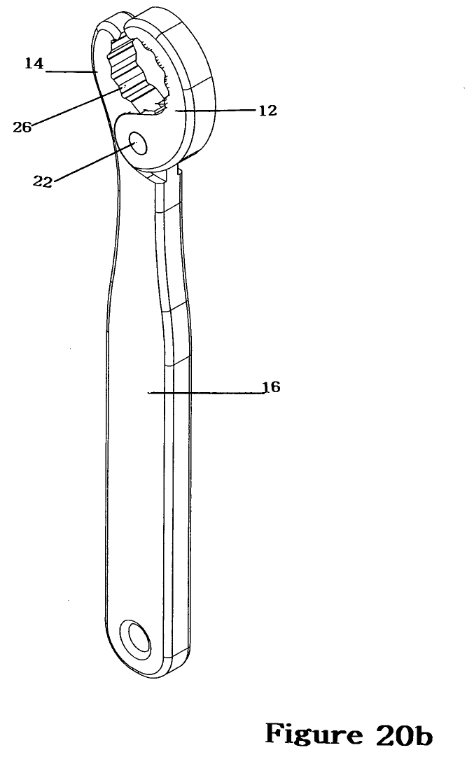

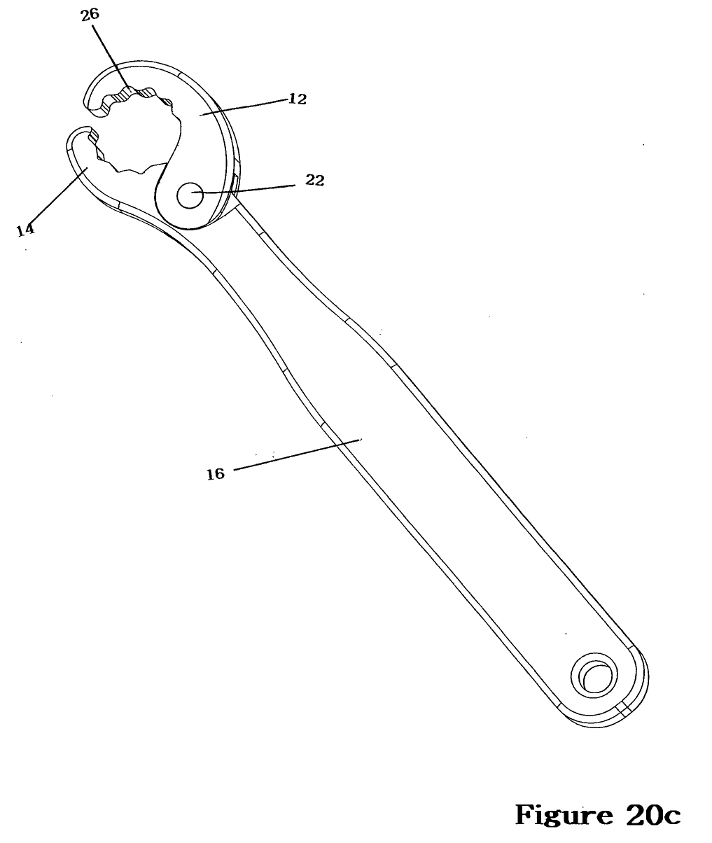

Wrench 10 mouth has a plurality of flat surfaces 26, which engage workpiece. For a hex bolt 50, mouth has at least six-points 26, but can have additional flat surfaces 26 such as twelve-points 26. Flats 26 are positioned to substantially exactly align with bearing surfaces 52a of workpiece 50 such as a hex bolt. In a six-point embodiment, flats are dimensioned to substantially exactly correspond to the dimensions of bearing surfaces 52a of workpiece 50. Angle α between each flat 26 is about 60°. In a twelve-point embodiment, angle α between each flat 26 is about 30°. The point between each flat can be a sharp corner or it can be radiused, i.e. made into a smooth curve. FIGS. 2a-2d show sharp corners and FIGS. 2e-2f show radiused corners. Radiused corners are preferred. Radiused corners are more mechanically efficient and provide tolerance for bolts with inexact dimensions. Whether the points have sharp corners or radiused corners, the angle α between each flat is 30° for a twelve-point embodiment and 60° for a sis-point embodiment.

In a six-point embodiment, the arc of ratchet is about 60°. In a twelve-point embodiment, the arc of ratchet is about 30°. Because the arc of ratchet of the twelve-point embodiment is smaller than the six-point embodiment, it can be used in tighter and smaller work spaces than the six-point embodiment. As the head of the wrench rotates, the handle rotates through the same arc, but because of the length of the handle, it travels a longer distance.

Bearing surfaces 52a of workpiece 50 are substantially encircled by jaws 12, 14 of wrench 10. Preferably, at least about 75% of bearing surface of the workpiece is encircled by jaws 12, 14 of wrench 10. More preferably at least 85% of bearing surfaces 52a of workpiece 50 are encircled by jaws 12, 14 of wrench 10.

In a six-point embodiment, fixed jaw 14 has three flats 26. First flat 26a adjacent to inclined shoulder 28, center flat 26b, and third flat 26c adjacent to moveable jaw 12. Moveable jaw 12 also has three flats. Center flat 26b′ of moveable jaw 12 is parallel to center flat 26b of fixed jaw 14. Third flat 26c′ is parallel to first flat 26a adjacent to third flat 26c. First flat 26a′ is preferably shorter than the length of a bearing surface 52a. In the six-point embodiment, center flat 26b is preferably angled about 23° from axis A of the tool.

In the twelve-point embodiment, the bearing surfaces 52a of workpiece 50 are each engaged by two flats 152a, 152a′ separated by a pair of flats 152b, 152b′.

Direction of pull P for either tightening or loosening is determined by the side of jaws 12, 14 relative to the workpiece. In the case of a right hand screw, tightening requires moveable jaw 12 to be on the right and loosening requires moveable jaw 12 on the left. For a left hand screw, moveable jaw 12 is on the left for tightening and on the right for loosening. When turning workpiece 50, the direction of the pull is towards fixed jaw 14. Disengagement between pulls is accomplished by turning in the opposite direction of pull. Wrench 10 rides over points 52b of workpiece 50 and automatically reseats itself at the adjacent flat 52a. In a six-point embodiment, the arc of ratchet is about 60°. In a twelve-point embodiment, the arc of ratchet is about 30°.

In one embodiment, wrench 10 has a grip 42. Preferably grip 42 is an ergonomic grip. Optionally, wrench 10 has a mouth on both ends.

Mouth can have different numbers of points and flats to accommodate workpieces of differing shapes. For example, wrench 10 may have eight-points. In an eight-point embodiment, each flat would be angled 400 from the adjacent flat.

1. A wrench comprising:
a lever having a fixed jaw at a first end;
a moveable jaw rotably connected to the lever;
said lever housing a first end of a compression spring and said moveable jaw housing a second end of the compression spring;
said fixed jaw having a first plurality of flats on an inner surface and said moveable jaw having a second plurality of flats on an inner surface;
said inner surfaces defining a wrench mouth;
said fixed jaw having a first inclined shoulder on an outer surface and said moveable jaw having a second inclined on an outer surface;
said first and second inclined shoulders defining a passage,
wherein said moveable jaw will open when at least said second inclined shoulders engages a workpiece and wherein the workpiece is seated when said moveable jaw is in a closed position.

2. The wrench of claim 1 further comprising a pair of shields on the lever.

3. The wrench of claim 1 further comprising a pair of notches in said level and a pair of legs on said moveable jaw wherein said legs are adapted to mate with said notches.

4. The wrench of claim 1 further comprising a pair of notches in said moveable jaw and a pair of legs on said level wherein said legs are adapted to mate with said notches.

5. The wrench of claim 1 wherein adjacent first flats define a first points and adjacent second flats define second points.

6. The wrench of claim 5 wherein the first and second points have sharp corners.

7. The wrench of claim 5 wherein the first and second points are radiused.

8. The wrench of claim 1 wherein the first inclined shoulder is angled about 8°-18° from an axis of the lever.

9. The wrench of claim 1 wherein the second inclined shoulder is angled about 35°-40° from an axis of the lever.

10. The wrench of claim 8 wherein the second inclined shoulder is angled about 35°-40° from an axis of the lever.

11. The wrench of claim 1 wherein the moveable jaw has a first bore and the lever has a second bore, said first bore angled about 33°-43° from an axis of the lever and said second bore angled about 33°-43° from the axis of the lever; and
wherein said bores align and house the spring.

12. The wrench of claim 11 further comprising a pin in said first bore.

13. The wrench of claim 1 further comprising a grip.

14. The wrench of claim 1 wherein the angle between adjacent flats is about 30°.

15. The wrench of claim 6 wherein the angle between adjacent flats is about 30°.

16. The wrench of claim 7 wherein the angle between adjacent flats is about 30°.

17. The wrench of claim 1 wherein the angle between adjacent flats is about 60°.

18. The wrench of claim 6 wherein the angle between adjacent flats is about 60°.

19. The wrench of claim 7 wherein the angle between adjacent flats is about 60°.

20. A wrench comprising:
a lever having a fixed jaw at a first end and a grip at a second end;
a moveable jaw rotably connected to the lever;
said lever housing a first end of a compression spring and said moveable jaw housing a second end of the compression spring;
said fixed jaw having a first plurality of flats on an inner surface and said moveable jaw having a second plurality of flats on an inner surface;
said inner surfaces defining a wrench mouth;
said fixed jaw having a first inclined shoulder on an outer surface and said moveable jaw having a second inclined on an outer surface; said first inclined shoulder is angled about 8°-18° from an axis of the lever and said second inclined shoulder angled about 35°-40° from an axis of the lever;
said first and second inclined shoulders defining a passage;
a pair of notches in said level and a pair of legs on said moveable jaw wherein said legs are adapted to mate with said notches;
a first pin; and
a connecting pin joining the moveable jaw and the level;
wherein adjacent first flats define a first points and adjacent second flats define second points;
the moveable jaw has a first bore and the lever has a second bore, said first bore angled about 33°-43° from an axis of the lever and said second bore angles about 33°-43° from the axis of the lever and said bores align to house the spring; said first pin is housed in said first bore; and
said moveable jaw will open when at least said second inclined shoulders engages a workpiece and wherein the workpiece is seated when said moveable jaw is in a closed position.

21. The wrench of claim 19 wherein the first and second points have sharp corners.

22. The wrench of claim 19 wherein the first and second points are radiused.

23. The wrench of claim 19 wherein the angle between adjacent flats is about 30°.

24. The wrench of claim 19 wherein the angle between adjacent flats is about 60°.
